(19) United States
(12) Patent Application Publication
(10) Pub. No.: US 2023/0223212 A1
(43) Pub. Date: Jul. 13, 2023

(54) Systems With Durable Coatings

(71) Applicant: Apple Inc., Cupertino, CA (US)

(72) Inventors: Ming Kun Shi, Morgan Hill, CA (US); Jing Zhang, Shanghai (CN); Lei Ding, Tianjin (CN); Liliya Lyandres, Sunnyvale, CA (US); Peter J. Guest, San Jose, CA (US)

(21) Appl. No.: 17/972,446

(22) Filed: Oct. 24, 2022

Related U.S. Application Data
(60) Provisional application No. 63/297,387, filed on Jan. 7, 2022.

(51) Int. Cl. H01H 13/14; H01H 13/04

(52) U.S. Cl. CPC H01H 13/14; H01H 13/04

(57) ABSTRACT

An electronic device may have input-output devices such as keyboard keys or other buttons. Components such as cameras and other devices may have trim structures. A housing may be used to form an enclosure for the components. Keyboard keys, trim structures, and/or other device structures such as housing structures may be provided with wear-resistant coatings. For example, a keyboard key may have a glyph such as an alphanumeric character formed from patterned layers of ink. To prevent wear to the key and glyph, the glyph may be coated with a wear-resistant coating. The wear-resistant coating may be formed from a polymer with embedded mineral particles such as aluminosilicate particles.

This application claims the benefit of provisional patent application No. 63/297,387, filed Jan. 7, 2022, which is hereby incorporated by reference herein in its entirety.

### FIELD

This relates generally to electronic devices, and, more particularly, to coatings for electronic devices.

### BACKGROUND

Electronic devices such as computers and other equipment may include structures that are touched by a user's fingers and other objects. The structures may have visible patterns and other features that are covered with coatings.

### SUMMARY

An electronic device may have input-output devices such as keyboard keys and other buttons. A user may provide button press input (key press input) to the keys during use of the electronic device. The electronic device may also have components such as cameras. Components in an electronic device may be surrounded by trim. The components may be mounted in housing walls that form an electronic device housing.

To prevent wear that might adversely affect surface appearance, the surfaces of keyboard keys and other buttons, trim structures, and/or other device structures such as housing structures may be provided with wear-resistant coatings. For example, a keyboard key may have a glyph such as an alphanumeric character formed from patterned layers of ink. The glyph and/or other structures in the device may be coated with a clear wear-resistant coating that allows the glyph to be viewed by a user. The wear-resistant coating may be formed from a polymer with embedded mineral particles such as aluminosilicate particles.

### BRIEF DESCRIPTION OF THE DRAWINGS

FIG. 1 is a schematic diagram of an illustrative system in accordance with an embodiment.

FIG. 2 is a side view of an illustrative electronic device having a structure with a coating in accordance with an embodiment.

FIG. 3 is a side view of an illustrative electronic device having a key member with a coating in accordance with an embodiment.

FIG. 4 is side view of an illustrative coating in accordance with an embodiment.

### DETAILED DESCRIPTION

An electronic device may have input-output devices. Input-output devices such as keys in a keyboard and other buttons may be pressed repeatedly by a user over the lifetime of the electronic device, giving rise to a potential for surface wear. Surface wear is also a risk for device structures that are repeatedly exposed to the environment such as electronic device housing structures and other structures in a device that come into contact with a user's body and other external objects.

To help prevent undesired surface wear while allowing underlying patterns and structures to be viewed, durable coatings may be applied to the surfaces of keys and other buttons and/or to other device structures such as housing structures. The durable coatings may be formed from curable polymer with embedded wear-resistance particles. In an illustrative configuration, the wear-resistance particles may be formed from hard particles (e.g., particles with a Mohs hardness value of 6-8, at least 6, at least 6.5, at least 7, at least 7.5, less than 8, or other suitable value).

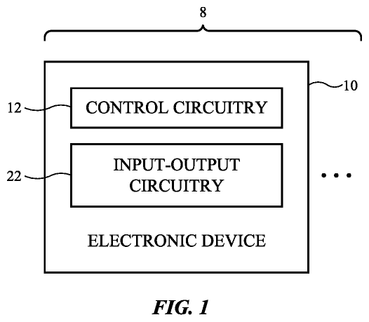

A schematic diagram of an illustrative system that may include electronic devices with wear-resistant coatings is shown in FIG. 1. As shown in FIG. 1, system 8 may include one or more electronic devices such as electronic device 10. The electronic devices of system 8 may include tablet computers, laptop computers, desktop computers, cellular telephones, head-mounted devices, wristwatch devices, computer stylus devices, remote control devices, computer mice, keyboards and other accessories, speakers (e.g., ear speakers, desktop speakers, etc.), and/or other devices. The devices may be wearable devices, handheld devices, desktop devices, portable devices, and/or other devices. The devices may include structures that are touched by a user and otherwise subjected to contact with external objects. These structures may include keys and other buttons, housing structures (e.g., enclosures, component trim structures, etc.), and/or other device structures. The coated structures may be formed from polymer, glass, metal, and/or other materials. In an illustrative configuration, printed patterns (e.g., alphanumeric text, icons, and/or other keyboard glyphs) may be coated with a wear-resistant coating.

Devices 10 have control circuitry 12 for controlling the operation of devices 10 and supporting communications between devices 10. Devices 10 may also have input-output circuitry 22 for gathering input (e.g., user input and input from the environment) and for providing output such as visual output, audio output, and/or haptic output). Circuitry 22 may include keyboard keys, buttons, touch sensors, and other input and output devices.

During use of system 8, one or more devices 10 may provide a user with content. The content may include visual content, audio content, haptic output, and/or other output. At the same time, one or more of these same devices 10 and/or other devices 10 in system 8 may use input-output circuitry 22 to gather user input that is used in interacting with the content. As an example, input-output circuitry 22 may have keys (buttons) and/or other input-output devices to gather user key press input or other button press input that is used to make menu selections, supply text to an application, and/or otherwise interact with system 8.

Control circuitry 12 may include storage and processing circuitry for controlling the operation of device 10. Circuitry 12 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 12 may be based on one or more microprocessors, microcontrollers, digital signal processors, baseband processors, power management units, audio chips, graphics processing units, application specific integrated circuits, and other integrated circuits. Software code may be stored on storage in circuitry 12 and run on processing circuitry in circuitry 12 to implement control operations for device 10 (e.g., data gathering operations, operations involving the adjustment of the components of device 10 using control signals, etc.). Control circuitry 12 may include wired and wireless communications circuitry. For example, control circuitry 12 may include radio-frequency transceiver circuitry such as cellular telephone transceiver circuitry, wireless local area network transceiver circuitry (e.g., WiFi® circuitry), millimeter wave transceiver circuitry, and/or other wireless communications circuitry.

During operation, the communications circuitry of the devices in system 8 (e.g., the communications circuitry of control circuitry 12 of devices 10), may be used to support communication between the electronic devices. For example, one electronic device may transmit video data, audio data, and/or other data to another electronic device in system 8. If desired, an electronic device may have a controller that gathers user input and this input may be used locally by that device and/or may be transmitted to another electronic device in system 8 (e.g., to control that remote device). Electronic devices in system 8 may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

Input-output devices in circuitry 22 may include input devices that allow a user to provide devices 10 with user input. Input-output devices may also be used to gather information on the environment in which a device is operating. Output components in circuitry 22 may allow devices 10 to provide a user with output and may be used to communicate with external electrical equipment.

Input-output circuitry 22 may include sensors. The sensors may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user's eyes), strain gauges, touch sensors, capacitive proximity sensors, light-based (optical) proximity sensors, other proximity sensors, force sensors, sensors such as contact sensors based on switches, gas sensors, pressure sensors, moisture sensors, magnetic sensors, audio sensors (microphones), ambient light sensors, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), and/or other sensors.

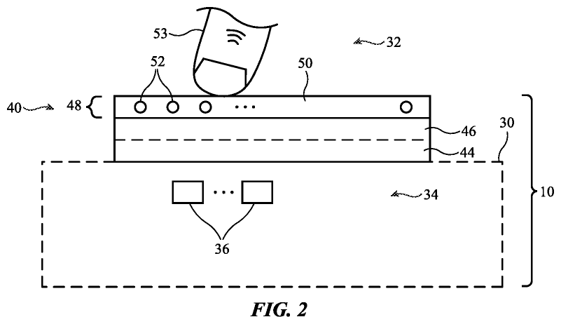

As shown in FIG. 2, each electronic device 10 in system 8 may have a housing such as housing 30. Housing 30 may have housing walls that separate exterior region 32 from interior region 34. Electrical components and other components 36 may be formed in interior region 34. Components 36 may include integrated circuits, sensors, buttons, batteries, and/or other components (see, e.g., control circuitry 12 and input-output circuitry of FIG. 1).

As illustrated by structure 40, some of components 36 (e.g., buttons) and/or some of the structures forming housing 30 may have surfaces that are exposed to exterior region 32. Structure 40 may be, for example, a button member (e.g., a keyboard key member), a housing wall, a component trim structure, and/or other structure in device 10. Structure 40 may have one or more different portions (see, e.g., support member 44 and optional layer(s) 46).

Structure 40 may be covered with wear-resistant coating 48. Coating 48 may include a polymer layer such as polymer layer 50 with embedded wear-resistance particles 52. When exposed to contact by a user's finger (e.g., finger 53) or other external structures, coating 48 may resist wear (e.g., coating 48 may resist burnishing due to repeated finger presses). If desired, coating 48 may be at least partly transparent, so that underlying glyphs and/or other patterns formed in layer(s) 44 may be viewed through coating 46.

Any suitable polymer material may be used in forming the polymer of polymer layer 50. As an example, polyurethane such as a self-matting polyurethane (e.g., a self-matting polyurethane polymer resin dispersed in water) or other water-based polymer, which may sometimes be referred to as a polyurethane dispersion may be used in forming layer 50. A hydrophobic polyurethane may be used, so that layer 50 and therefore coating 48 are hydrophobic (e.g., so that the water contact angle of layer 50 is at least 90°). If desired, the polyurethane or other polymer of layer 50 may exhibit a water contact angle of at least 70°, at least 80°, 85-95°, or other water contact angle.

Layer 50 may be dispensed in liquid form using any suitable coating tool (e.g., a screen printing tool, a pad printing tool, a spray coating tool, a casting tool, etc.). Following deposition, the liquid polymer material of layer 50 may be cured. In an illustrative configuration, layer 50 is cured by light exposure (e.g., layer 50 is formed from a light-curable polymer such as an ultraviolet-light-curable polyurethane). Thermal curing techniques and hybrid curing techniques that involve the use of both ultraviolet-light curing and thermal curing may also be used, if desired.

Wear-resistance-promotion particles such as wear-resistance particles 52 may be embedded in the liquid polymer used in forming layer 50. Particles 52 may be formed from a hard material such as material with a Mohs hardness value of 6-8, at least 6, at least 6.5, at least 7, at least 7.5, less than 8, or other suitable value. In an illustrative configuration, particles 52, which may sometimes be referred to as hardening particles, may be aluminosilicate particles (particles of aluminosilicate powder) or other mineral particles. Particles 52 may be spherical or may have other shapes. The mean diameter of particles 52 may be at least 1.5 microns, at least 2 microns, at least 5 microns, at least 10 microns, less than 30 microns, less than 20 microns, less than 15 microns, less than 7 microns, 2-20 microns, 5-10 microns, 1-30 microns, or other suitable value. The diameter of particles 52 is preferably sufficiently small that most or all particles 52 have a diameter less than the thickness of layer 50. The thickness of layer 50 may be, for example, 13-18 microns, at least 2 microns, at least 4 microns, at least 8 microns, at least 10 microns, less than 50 microns, less than 30 microns, less than 20 microns, less than 15 microns, 5-20 microns, 10-20 microns, or other suitable thickness. To help ensure that particles 52 wet out satisfactorily within the liquid polymer of layer 50, particles 52 may be alkaline-coated particles (e.g., alkaline coated aluminosilicate particles). The concentration of particles 52 in polymer layer 50 may be less than 40% by weight, less than 30% by weight, less than 25% by weight, less than 20% by weight, less than 15% by weight, less than 10% by weight, less than 5% by weight, less than 3% by weight, less than 2% by weight, less than 1% by weight, less than 0.5% by weight, 0.5%-3% by weight, 0.1%-3% by weight, 0.1-1% by weight, 0.2-5% by weight, 1-40% by weight, 10-40% by weight, and/or at least 0.2% by weight, at least 0.5% by weight, at least 1% by weight, 0.3%-5% by weight, more than 1% by weight, more than 5% by weight, more than 10% by weight, or other suitable concentration.

If desired, colorant (e.g., dye and/or pigment) and/or haze-inducing particles (e.g., titanium dioxide particles, silica particles, or other particles with a refractive index that differs from that of the polymer material in layer 50) may be included in layer 50. Layer 50 and/or layer(s) 46 under layer 50 may be patterned using printing, laser ablation, machining, and/or other patterning techniques.

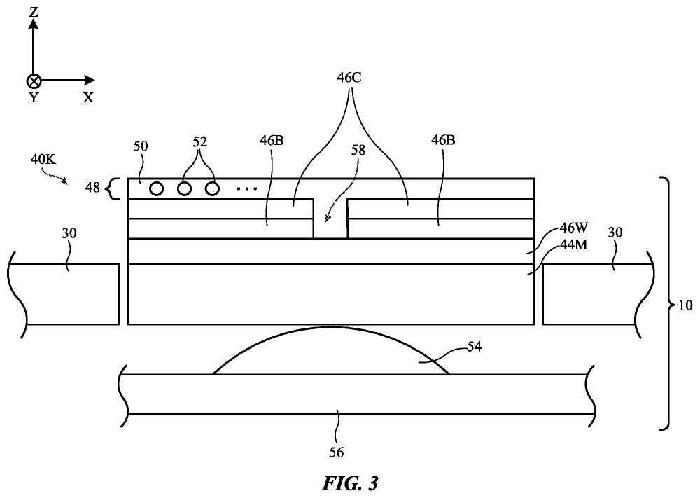

Coating 48 may be used to protect patterned layers of ink and/or other patterned structures (as an example). Consider, as an example, the illustrative configuration of FIG. 3. As shown in FIG. 3, device 10 may include one or more buttons such as keyboard key 40K in device housing 30. Key 40K may have a movable key (button) member 44M (e.g., a molded polymer member in the shape of a key). Springs and/or other biasing structures may be used to allow key member 44M to travel up and down along the Z axis of FIG. 3. When depressed by a key press from a user's finger (e.g., when moved in the −Z direction of FIG. 3), key switch 54 (e.g., a dome switch on printed circuit 56) may be depressed by member 44M and thereby closed. Control circuitry 12 can detect the closure of switch 54 to detect the finger key press input. Keys such a key 40K may be formed in laptop computer keyboards, stand-alone accessory keyboards, keypads, and/or other devices with buttons.

As shown in FIG. 3, key member 44M may be coated with one or more layers such as illustrative layers 46W, 46B, and 46C. Layer 46W may be, for example, a white ink layer having a thickness of 8-12 microns or other suitable thickness. Layer 46B may be a black ink layer having a thickness of 15-20 microns or other suitable thickness. Layer 46B may be patterned (e.g., using laser ablation or other patterning techniques) to form key glyph 58 (e.g., an alphanumeric character such as a letter, number, or symbol for a computer key). Optional color adjustment layer 46C (e.g., a dark blue ink layer), which may also be patterned using laser ablation or other patterning techniques, may be used to help adjust the appearance of key 40K. Coating 48 may include polymer layer 50 with embedded particles 52. Coating 48 may be transparent (e.g., clear) so that a user may view glyph 58 through coating 48. The wear resistance provided by coating 48 may help prevent damage to glyph 58 and may help prevent undesired changes in the appearance of key 40K (e.g., layers such as layer a layers 46W, 46B, and 46C will be protected from wear by a user's fingers). The wear resistance of coating 48 may help prevent coating 48 from becoming burnished and thereby acquiring an overly glossy appearance over the lifetime of device 10.

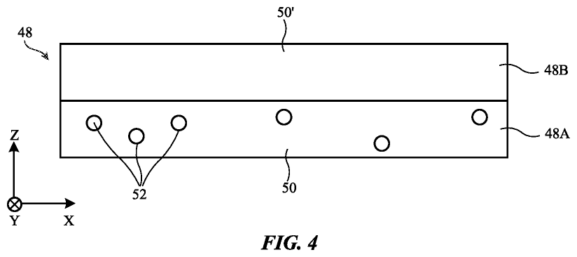

If desired, coating 48 may contain multiple sublayers such as lower layer 48A and upper layer 48B of FIG. 4. Lower layer 48A may have particles 52 in polymer layer 50, as described in connection with FIGS. 2 and 3. The thickness of layer 48A may be 7-10 microns, at least 2 microns, at least 3 microns, at least 4 microns, at least 5 microns, less than 30 microns, less than 25 microns, less than 20 microns, less than 15 microns, 2-30 microns, 3-15 microns, or other suitable thickness. The concentration of particles 52 in polymer layer 50 may be less than 40% by weight, less than 30% by weight, less than 25% by weight, less than 20% by weight, less than 15% by weight, less than 10% by weight, less than 5% by weight, less than 3% by weight, less than 2% by weight, less than 1% by weight, less than 0.5% by weight, 0.5%-3% by weight, 0.1%-3% by weight, 0.1-1% by weight, 0.2-5% by weight, 1-40% by weight, 10-40% by weight, and/or at least 0.2% by weight, at least 0.5% by weight, at least 1% by weight, 0.3%-5% by weight, more than 1% by weight, more than 5% by weight, more than 10% by weight, or other suitable concentration. Layer 48B may cover layer 48A and may be used to provide a surface that is smooth to the touch for a user. Layer 48B may have a concentration of particles 52 that is less than the concentration of particles 52 in layer 48A and may, as shown in the example of FIG. 4, be free of particles 52 (e.g., layer 48B may be formed from a layer of polymer such as polymer layer 50′ that does not contain wear-resistance particles). The polymer material of layer 50′ may be the same as the polymer material of layer 50 or layers 50′ and 50 may be formed from different polymers. To ensure that key glyphs under layer 48 are visible, layers 50 and 50′ may be formed from clear polymer. In an illustrative arrangement, layer 50′ may be formed from a polymer such as a self-matting polyurethane (e.g., a self-matting polyurethane polymer resin dispersed in water) or other water-based polymer, which may sometimes be referred to as a polyurethane dispersion. A hydrophobic polyurethane may be used, so that layer 50′ and therefore coating 48 are hydrophobic (e.g., so that the water contact angle of layer 50′ on the surface of coating 48 is at least 90°). As with layer 50, layer 50′ may be dispensed in liquid form using any suitable coating tool (e.g., a screen printing tool, a pad printing tool, a spray coating tool, a casting tool, etc.). Following deposition, the liquid polymer material of layer 50′ may be cured. In an illustrative configuration, layer 50′ may be cured by light exposure (e.g., layer 50′ may be formed from a light-curable polymer such as an ultraviolet-light-curable polyurethane). Thermal curing techniques and hybrid curing techniques that involve the use of both ultraviolet-light curing and thermal curing may also be used, if desired. The thickness of layer 48B may be 7-10 microns, at least 2 microns, at least 3 microns, at least 4 microns, at least 5 microns, less than 30 microns, less than 25 microns, less than 20 microns, less than 15 microns, 2-30 microns, 3-15 microns, or other suitable thickness. By using a hybrid coating arrangement of the type shown in FIG. 4, layer 48A may help provide coating 48 with wear resistance and layer 48B may help provide coating 48 with a smooth feel when touched by the finger of a user.

In some embodiments, device 10 may gather personal user information. To ensure that the privacy of users is preserved, all applicable privacy regulations should be met or exceeded and best practices for handling of personal user information should be followed. Users may be permitted to control the use of their personal information in accordance with their preferences.

The foregoing is merely illustrative and various modifications can be made to the described embodiments. The foregoing embodiments may be implemented individually or in any combination.

What is claimed is:

1. An electronic device, comprising:
a housing;
a button in the housing having a button member; and
a coating on the button member, wherein the coating comprises a polymer layer with embedded hardening particles.

2. The electronic device defined in claim 1 wherein the button further comprises a switch and wherein the button member comprises a movable button member configured to press against the switch.

3. The electronic device defined in claim 2 wherein the button comprises at least one patterned layer forming an alphanumeric character and wherein the coating covers the alphanumeric character.

4. The electronic device defined in claim 3 wherein the polymer layer comprises clear polyurethane.

5. The electronic device defined in claim 3 wherein the coating comprises an additional polymer layer on the polymer layer and wherein the additional polymer layer does not contain any embedded hardening particles.

6. The electronic device defined in claim 3 wherein the hardening particles comprise mineral particles.

7. The electronic device defined in claim 3 wherein the hardening particles comprise wear-resistance particles having a Mohs hardness value of at least 6.0.

8. The electronic device defined in claim 3 wherein the hardening particles comprise aluminosilicate particles.

9. The electronic device defined in claim 3 wherein the hardening particles comprise spherical alkaline-coated aluminosilicate particles having a mean diameter of less than 20 microns and wherein the polymer comprises ultraviolet-cured polyurethane.

10. The electronic device defined in claim 3 wherein the coating comprises an additional polymer layer on the polymer layer and wherein the additional polymer layer does not contain any embedded hardening particles and comprises self-matting polyurethane.

11. The electronic device defined in claim 3 wherein the coating comprises a hydrophobic polymer having a water contact angle of at least 70°.

12. The electronic device defined in claim 3 wherein the coating comprises a water-based polymer selected from the group consisting of polyurethane and acrylic, wherein the coating has a thickness of 5-20 microns, wherein the hardening particles have a mean diameter of less than 20 microns, and wherein the patterned layer comprises a patterned black layer on a white layer.

13. An electronic device having an interior region, comprising:
an electrical component;
trim surrounding the electrical component;
a housing wall surrounding the interior region;
a button having a button member; and
a coating having a clear polymer with embedded wear-resistance particles,
wherein the coating is configured to cover a surface on a selected one of: the trim, the button member, and the housing wall.

14. The electronic device defined in claim 13 wherein the coating comprises an additional polymer layer on the polymer layer, wherein the additional polymer layer does not contain any embedded hardening particles, wherein the additional polymer comprises polyurethane having a water contact angle of at least 70°, and wherein the embedded wear-resistance particles comprise aluminosilicate particles incorporated into the polyurethane at a concentration of less than 20% by weight.

15. The electronic device defined in claim 14 wherein the surface comprises a patterned structure configured to form a key glyph and wherein the aluminosilicate particles have a mean diameter of less than 20 microns.

16. A keyboard key, comprising:
a key member;
a switch, wherein the key member is configured to press against the switch;
a key glyph on the key member; and
a clear polymer layer with embedded particles that covers the key glyph.

17. The keyboard key defined in claim 16 wherein the embedded particles comprise mineral particles.

18. The keyboard key defined in claim 17 wherein the coating comprises an additional polymer layer on the polymer layer, wherein the clear polymer layer is between the additional polymer layer and the key glyph, wherein the additional polymer layer does not contain any embedded hardening particles, and wherein the clear polymer layer with the embedded particles forms a coating that contains less than 20% embedded particles by weight.

19. The keyboard key defined in claim 17 wherein the mineral particles comprise aluminosilicate particles and wherein the clear polymer layer comprises a polyurethane layer.

20. The keyboard key defined in claim 19 wherein the key glyph comprises a layer of a first ink having a first color covered with a patterned layer of a second ink having a second color that is different than the first color and wherein the mineral particles have a mean diameter of less than 20 microns.
